(19) United States
(12) Patent Application Publication
(10) Pub. No.: US 2024/0276273 A1
(43) Pub. Date: Aug. 15, 2024

(54) SERVICE CONTINUITY FROM INDIRECT TO DIRECT COMMUNICATION TRIGGERED BY MESSAGING FROM THE RELAY UE DEVICE

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/569,326

(22) PCT Filed: Jul. 14, 2022
(86) PCT No.: PCT/US2022/037062

§ 371 Date: Dec. 12, 2023

Related U.S. Application Data
(60) Provisional application No. 63/222,303, filed on Jul. 15, 2021.

(51) Int. Cl. H04W 24/10; H04W 88/04

(52) U.S. Cl. CPC H04W 24/10; H04W 88/04

(57) ABSTRACT

The devices, systems, and methods discussed herein facilitate the transition of a remote user equipment (UE) device from an indirect path of communication with a base station to a direct path of communication with the base station. More specifically, a relay UE device transmits, to a remote UE device that is indirectly communicating with a base station via the relay UE device, a message indicating that the quality of a communication link between the relay UE device and the base station is below a threshold. In response to receiving the message, the remote UE device transmits a measurement report to the base station. In some examples, the remote UE device starts a timer upon transmission of the measurement report to the base station. In these examples, the timer is used to control the frequency with which the remote UE device transmits additional measurement reports to the base station.

### CLAIM OF PRIORITY

The present application claims priority to Provisional Application No. 63/222,303, entitled “SERVICE CONTINUITY UNDER L2 SIDELINK RELAYING,” docket number TPRO 00363 US, filed Jul. 15, 2021, which is assigned to the assignee hereof and hereby expressly incorporated by reference in its entirety.

### FIELD

This invention generally relates to wireless communications and more particularly to transitioning a wireless communication device from indirect to direct communication with a base station.

### BACKGROUND

Sidelink relaying functionality allows a remote user equipment (UE) device that is out-of-coverage (OoC) to connect with the gNB or base station via a relay UE device.

### SUMMARY

The devices, systems, and methods discussed herein facilitate the transition of a remote user equipment (UE) device from an indirect path of communication with a base station to a direct path of communication with the base station. More specifically, a relay UE device transmits, to a remote UE device that is indirectly communicating with a base station via the relay UE device, a message indicating that the quality of a communication link between the relay UE device and the base station is below a threshold. In response to receiving the message, the remote UE device transmits a measurement report to the base station. In some examples, the remote UE device starts a timer upon transmission of the measurement report to the base station. In these examples, the timer is used to control the frequency with which the remote UE device transmits additional measurement reports to the base station.

### BRIEF DESCRIPTION OF THE DRAWINGS

FIG. 1A is a block diagram of an example of a system in which a remote user equipment (UE) device is indirectly communicating with a base station via a relay UE device.

FIG. 1B is a block diagram of an example of the system of FIG. 1A in which the remote UE device has transitioned to directly communicating with the base station.

FIG. 2A is a block diagram of an example of the base station shown in FIGS. 1A and 1B.

FIG. 2B is a block diagram of an example of the user equipment devices shown in FIGS. 1A and 1B.

FIG. 3 is a flowchart of an example of a method in which a remote UE device receives, from a relay UE device, a message indicating that the quality of a communication link between the relay UE device and a base station is below a threshold. In response to receiving the message from the relay UE device, the remote UE device transmits a measurement report to the base station.

### DETAILED DESCRIPTION

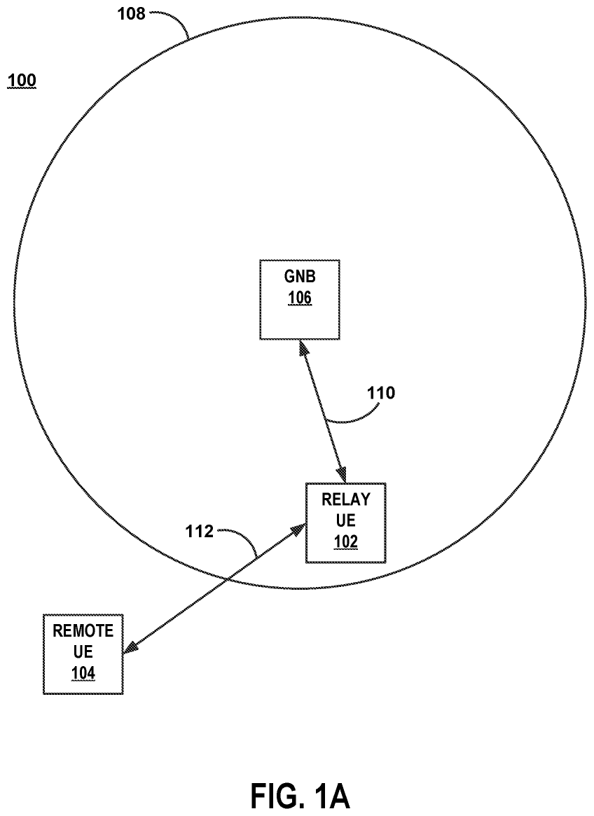

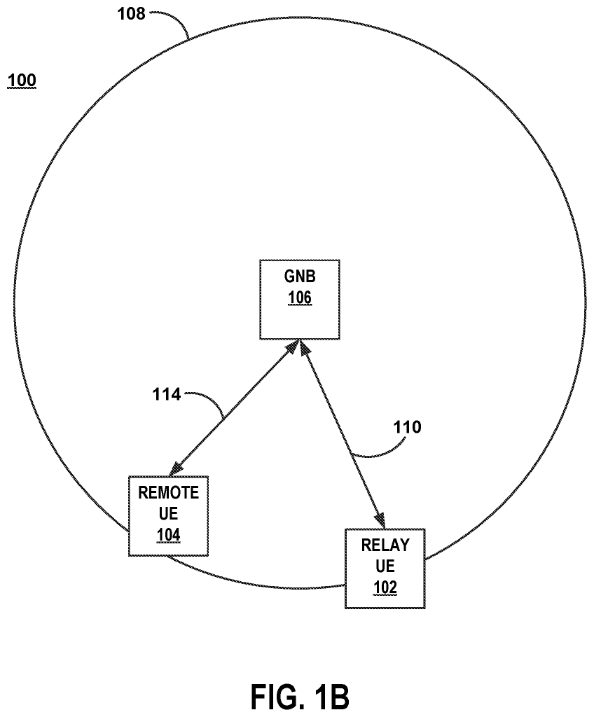

There are two types of sidelink relaying: UE-to-Network (U2N) relaying and UE-to-UE (U2U) relaying. For U2N relaying, both the relay UE and remote UE may be in coverage, but in other cases, the relay UE is in coverage while the remote UE is out-of-coverage (OoC), as shown in the example of FIG. 1A. Therefore, for U2N relaying, the relay UE needs to be in coverage of a cell and connected to the gNB (e.g., base station) that provides wireless services within the cell. With U2U relaying, there is no such restriction. Thus, for U2U relaying, the relay UE may be in coverage or OoC of the cell.

For U2N relaying, relaying of unicast data between the remote UE and the network can occur after a PC5-RRC connection is established between the relay UE and the remote UE. In this context, PC5 refers to an interface that allows UEs to communicate directly with each other over a direct channel. Thus, communication over the PC5 interface does not require communication with the base station. RRC refers to the Radio Resource Control (RRC) protocol that facilitates the following functionality: connection establishment and release functions, broadcast of system information, radio bearer establishment, and reconfiguration and release.

Since the remote UE and the relay UE are not assumed to be stationary relative to each other, the PC5 link between the remote UE and the relay UE may get worse over time, depending on their movement relative to each other. This is also true for the Uu link between the relay UE and the gNB. However, it is also possible that the remote UE may move in-Coverage of the gNB, in which case a path switch may be performed to switch the remote UE from the indirect path (e.g., via the relay UE) to the direct path (e.g., directly connected to the gNB via a Uu link).

Although there may be many potential issues with path switches, this disclosure discusses the indirect to direct path switch, which may be triggered when the Uu link between the relay UE and the gNB worsens. For example, if the Uu link between the relay UE and the gNB worsens, the relay UE will send its measurement report to the gNB (e.g., after a configured measurement event is triggered). If the remote UE's existing indirect connection to the gNB via the relay UE will no longer work due to the worsening Uu link between the relay UE and the gNB, the remote UE may need to perform a handover to direct communication with the gNB. However, the remote UE may be unaware of the poor Uu link unless the gNB or the relay UE informs the remote UE or if some data or signal relayed to the gNB is unsuccessful.

In order to facilitate the gNB's determination whether the remote UE should be switched from an indirect path to a direct path, the gNB must obtain an up-to-date measurement report from the remote UE. However, UE devices indirectly communicating with a base station (e.g., remote UE devices) are not currently configured to send an updated measurement report at the time when the Uu link between the relay UE and the gNB worsens. Thus, there needs to be a mechanism by which the remote UE is triggered to send a measurement report to the gNB.

The devices, systems, and methods discussed herein facilitate the transition of a remote user equipment (UE) device from an indirect path of communication with a base station to a direct path of communication with the base station. More specifically, a relay UE device transmits, to a remote UE device that is indirectly communicating with a base station via the relay UE device, a message indicating that the quality of a communication link between the relay UE device and the base station is below a threshold. In response to receiving the message, the remote UE device transmits a measurement report to the base station. In some examples, the remote UE device also starts a timer upon transmission of the measurement report to the base station. In some examples, the remote UE device transmits another measurement report upon expiration of the timer. In other examples, the remote UE device refrains from transmitting another measurement report prior to expiration of the timer.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

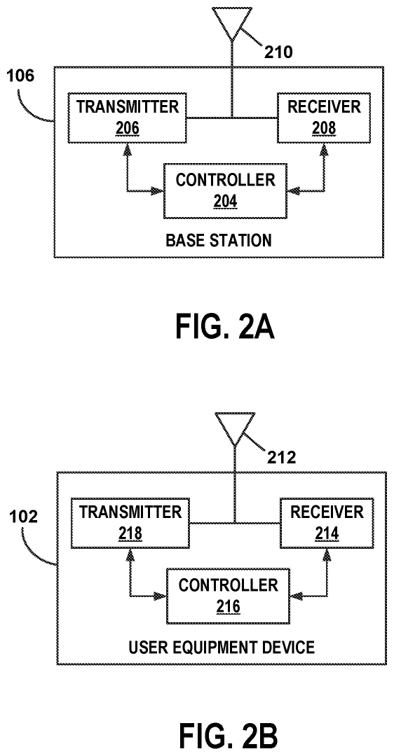

FIG. 1A is a block diagram of an example of a system in which a remote user equipment (UE) device is indirectly communicating with a base station via a relay UE device. In the interest of brevity, FIG. 1A only depicts one relay UE device 102 and one remote UE device 104. However, any number of relay UE devices and remote UE devices may be utilized, in other examples. As shown in FIG. 2B, user equipment device (UE) 102 comprises controller 216, transmitter 218, receiver 214, and antenna 212, as well as other electronics, hardware, and software code. Relay UE device 102 may also be referred to herein as a relay UE or as a relay wireless communication device (WCD). UE 102 is wirelessly connected to a radio access network (not shown) via base station 106, which provides various wireless services to UE 102. For the example shown in FIG. 1A, UE 102 operates in accordance with at least one revision of the 3rd Generation Partnership Project 5G New Radio (3GPP 5G NR) communication specification. In other examples, UE 102 may operate in accordance with other communication specifications. For the example shown in FIG. 1A, both of the UEs have the same components, circuitry, and configuration as UE 102 from FIG. 2B. However, any of the UEs in FIG. 1A may have components, circuitry, and configuration that differ from UE 102, in other examples.

UE 102 is any fixed, mobile, or portable equipment that performs the functions described herein. The various functions and operations of the blocks described with reference to UE 102 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a user equipment device. An example of a suitable controller 216 includes software code running on a microprocessor or processor arrangement connected to memory. Transmitter 218 includes electronics configured to transmit wireless signals. In some situations, transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2B perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the user equipment device functions. The required components may depend on the particular functionality required by the user equipment device.

Transmitter 218 includes a modulator (not shown), and receiver 214 includes a demodulator (not shown). The modulator can apply any one of a plurality of modulation orders to modulate the signals to be transmitted by transmitter 218. The demodulator demodulates received signals, in accordance with one of a plurality of modulation orders.

In the interest of clarity and brevity, only one base station is shown in FIG. 1A. However, in other examples, any suitable number of base stations may be utilized. In the example of FIG. 1A, base station 106 provides wireless services to UEs within coverage area 108. Although not explicitly shown, coverage area 108 may be comprised of multiple cells. For the example shown in FIG. 1A, base station 106, sometimes referred to as a gNodeB or gNB, can receive uplink messages from UE devices and can transmit downlink messages to the UE devices.

Base station 106 is connected to the network through a backhaul (not shown) in accordance with known techniques. As shown in FIG. 2A, base station 106 comprises controller 204, transmitter 206, receiver 208, and antenna 210 as well as other electronics, hardware, and code. Base station 106 is any fixed, mobile, or portable equipment that performs the functions described herein. The various functions and operations of the blocks described with reference to base station 106 may be implemented in any number of devices, circuits, or elements. Two or more of the functional blocks may be integrated in a single device, and the functions described as performed in any single device may be implemented over several devices.

For the example shown in FIG. 2A, base station 106 may be a fixed device or apparatus that is installed at a particular location at the time of system deployment. Examples of such equipment include fixed base stations or fixed transceiver stations. In some situations, base station 106 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, base station 106 may be a portable device that is not fixed to any particular location. Accordingly, base station 106 may be a portable user device such as a UE device in some circumstances.

Controller 204 includes any combination of hardware, software, and/or firmware for executing the functions described herein as well as facilitating the overall functionality of base station 106. An example of a suitable controller 204 includes code running on a microprocessor or processor arrangement connected to memory. Transmitter 206 includes electronics configured to transmit wireless signals. In some situations, transmitter 206 may include multiple transmitters. Receiver 208 includes electronics configured to receive wireless signals. In some situations, receiver 208 may include multiple receivers. Receiver 208 and transmitter 206 receive and transmit signals, respectively, through antenna 210. Antenna 210 may include separate transmit and receive antennas. In some circumstances, antenna 210 may include multiple transmit and receive antennas.

Transmitter 206 and receiver 208 in the example of FIG. 2A perform radio frequency (RF) processing including modulation and demodulation. Receiver 208, therefore, may include components such as low noise amplifiers (LNAs) and filters. Transmitter 206 may include filters and amplifiers. Other components may include isolators, matching circuits, and other RF components. These components in combination or cooperation with other components perform the base station functions. The required components may depend on the particular functionality required by the base station.

Transmitter 206 includes a modulator (not shown), and receiver 208 includes a demodulator (not shown). The modulator modulates the signals that will be transmitted and can apply any one of a plurality of modulation orders. The demodulator demodulates any uplink signals received at base station 106 in accordance with one of a plurality of modulation orders.

For the example shown in FIG. 1A, base station 106 and relay UE device 102 are connected by Uu link 110, which is the radio interface between a base station and a UE device. Relay UE device 102 and remote UE device 104 are connected by PC5 link 112, which is an interface that allows UEs to communicate directly with each other over a direct channel. Other suitable types of communication links may be utilized in system 100, in other examples.

In operation, remote UE device 104 is indirectly communicating with base station 106 via relay UE device 102, in the example shown in FIG. 1A. However, as relay UE device 102 moves farther away from base station 106 as shown in FIG. 1B, the quality of Uu communication link 110 begins to worsen. In some examples, relay UE device 102 is configured by base station 106 with one or more measurement events that will trigger relay UE device 102 to measure, via its antenna 212 and receiver 214, the quality of Uu communication link 110. In some examples, relay UE device 102 will send a measurement report regarding the quality of Uu communication link 110 to base station 106.

For the example shown in FIG. 1A, once the quality of Uu communication link 110 is below a threshold, relay UE device 102 utilizes its transmitter 218 and antenna 212 to transmit a message to remote UE device 104. In some examples, the message is a PC5-Radio Resource Control (PC5-RRC) message. In some examples in which the message is a PC5-RRC message, relay UE device 102 may be configured to transmit the PC5-RRC message in accordance with an instruction received from base station 106. Thus, in some further examples, relay UE device 102 may only transmit the PC5-RRC message if instructed to do so by base station 106.

Regardless of the type of message sent to remote UE device 104 from relay UE device 102, the message indicates that the quality of Uu communication link 110 is below a threshold. In some examples, the threshold is associated with threshold configuration information received at relay UE device 102 from base station 106.

Remote UE device 104 receives, via its antenna 212 and receiver 214, the message from relay UE device 102. In response to reception of the message from relay UE device 102, remote UE device 104 is triggered to transmit, via its transmitter 218 and antenna 212, a measurement report to base station 106. In some examples, the measurement report contains information pertaining to the signal quality of signals received at remote UE device 104 from base station 106 and/or one or more relay UE devices. In some examples, remote UE device 104 measures the signal quality of the signals received from base station 106, in response to the message received from relay UE device 102. In other examples, remote UE device 104 merely generates the measurement report from measurements that had been taken prior to receiving the message from relay UE device 102.

In some examples, upon transmission of the measurement report, remote UE device 104 utilizes its controller 216 to start a timer, which is based on timer configuration information received from base station 106. Upon expiration of the timer, remote UE device 104 transmits, via its transmitter 218 and antenna 212, another measurement report to base station 106, in some examples.

In other examples, remote UE device 104 refrains from transmitting another measurement report prior to expiration of the timer. In some of these examples, remote UE device 104 is triggered (e.g., via a triggering event) to transmit a measurement report and starts a timer upon transmission of the measurement report, and if prior to expiration of the timer, remote UE device 104 receives a message indicating that the quality of Uu communication link 110 between relay UE device 102 and base station 106 is below the threshold, remote UE device 104 refrains from transmitting another measurement report, even upon expiration of the timer. In some examples, a triggering event may be any one or more of the following: receiving a message indicating that the quality of the Uu communication link between the relay UE device and the base station is below a threshold, if a PC5 link between the relay UE device and the remote UE device is below a threshold, and if the Uu communication link between the remote UE device and the base station exceeds a threshold. In other examples, if remote UE device 104 receives, after expiration of the timer, a message indicating that the quality of Uu communication link 110 between relay UE device 102 and base station 106 is below the threshold, remote UE device 104 transmits, via its transmitter 218 and antenna 212, another measurement report to base station 106.

As remote UE device 104 moves closer to base station 106 as shown in FIG. 1B, it is likely that the measurement report transmitted by remote UE device 104 will reflect an improvement in the signal quality of the signals received at remote UE device 104 from base station 106. Thus, in some examples, base station 106 will determine whether remote UE device 104 should be transitioned from an indirect communication path to a direct communication path, based at least partially on the measurement report(s) received from remote UE device 104 and/or the measurement report received from relay UE device 102.

Once base station 106 has determined that remote UE device 104 should transition to a direct communication path, base station 106 will transmit a handover command to remote UE device 104 via relay UE device 102, in some examples. Upon completion of the handover procedure, remote UE device 104 directly communicates with base station 106. As shown in the example of FIG. 1B, remote UE device 104 and base station 106 communicate directly via Uu communication link 114.

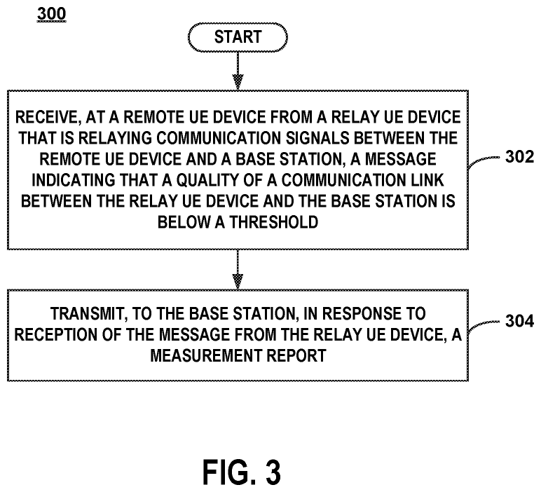

FIG. 3 is a flowchart of an example of a method in which a remote UE device receives, from a relay UE device, a message indicating that the quality of a communication link between the relay UE device and the base station is below a threshold. In response to receiving the message from the relay UE device, the remote UE device transmits a measurement report to the base station. The method 300 begins at step 302 with receiving, at a remote UE device from a relay UE device that is relaying communication signals between the remote UE device and a base station, a message indicating that the quality of a communication link between the relay UE device and the base station is below a threshold. At step 304, the remote UE device transmits, to the base station, in response to receiving the message from the relay UE device, a measurement report. In other examples, one or more of the steps of method 300 may be omitted, combined, performed in parallel, or performed in a different order than that described herein or shown in FIG. 3. In still further examples, additional steps may be added to method 300 that are not explicitly described in connection with the example shown in FIG. 3.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A relay user equipment (UE) device comprising:
a transmitter configured to transmit, to a remote UE device that is indirectly communicating with a base station via the relay UE device, a message indicating that a quality of a communication link between the relay UE device and the base station is below a threshold, transmission of the message to the remote UE device triggers the remote UE device to transmit a measurement report to the base station.

2. The relay UE device of claim 1, wherein the message is a PC5-Radio Resource Control (PC5-RRC) message.

3. The relay UE device of claim 2, wherein the transmitter is further configured to transmit the PC5-RRC message in accordance with an instruction received from the base station.

4. The relay UE device of claim 1, wherein the communication link between the relay UE device and the base station is a Uu communication link.

5. The relay UE device of claim 1, further comprising:
a receiver configured to receive, from the base station, threshold configuration information.

6. A remote user equipment (UE) device comprising:
a receiver configured to receive, from a relay UE device that is relaying communication signals between the remote UE device and a base station, a message indicating that a quality of a communication link between the relay UE device and the base station is below a threshold; and
a transmitter configured to transmit, to the base station, in response to reception of the message from the relay UE device, a measurement report.

7. The remote UE device of claim 6, wherein the message is a PC5-Radio Resource Control (PC5-RRC) message.

8. The remote UE device of claim 6, wherein the communication link between the relay UE device and the base station is a Uu communication link.

9. The remote UE device of claim 6, further comprising:
a controller configured to, upon transmission of the measurement report, start a timer, the timer based on timer configuration information received from the base station.

10. The remote UE device of claim 9, wherein the transmitter is further configured to transmit another measurement report upon expiration of the timer.

11. The remote UE device of claim 9, wherein the transmitter is further configured to refrain from transmitting another measurement report prior to expiration of the timer.

12. The remote UE device of claim 11, wherein the remote UE device is triggered to transmit another measurement report prior to expiration of the timer, the transmitter further configured to refrain from transmitting another measurement report upon expiration of the timer.

13. The remote UE device of claim 11, wherein the remote UE device is triggered to transmit another measurement report after expiration of the timer, the transmitter further configured to transmit another measurement report when the remote UE device is triggered by a triggering event.

14. A base station comprising:
a transmitter configured to transmit, to a relay user equipment (UE) device that is relaying communication signals between the base station and a remote UE device, threshold configuration information such that the relay UE device transmits a message to the remote UE device when a quality of a communication link between the relay UE device and the base station is below a threshold associated with the threshold configuration information, transmission of the message from the relay UE device to the remote UE device triggers the remote UE device to transmit a measurement report to the base station; and
a receiver configured to receive the measurement report from the remote UE device.

15. The base station of claim 14, wherein the message transmitted from the relay UE device to the remote UE device is a PC5-Radio Resource Control (PC5-RRC) message.

16. The base station of claim 14, wherein the communication link between the relay UE device and the base station is a Uu communication link.

17. The base station of claim 14, wherein the transmitter is further configured to transmit, to the remote UE device, timer configuration information such that the remote UE device starts a timer upon transmission of the measurement report, the timer based on the timer configuration information.

18. The base station of claim 17, wherein the remote UE device refrains from transmitting another measurement report until the timer expires.

19. The base station of claim 17, wherein the remote UE device refrains from transmitting another measurement report until the remote UE device is triggered to transmit another measurement report after expiration of the timer.
